(19) United States
(12) Patent Application Publication
(10) Pub. No.: US 2006/0255022 A1
(43) Pub. Date: Nov. 16, 2006

(54) Wafer laser processing method and laser beam processing machine

(76) Inventors: Hitoshi Hoshino, Tokyo (JP); Kenji Furuta, Tokyo (JP); Ryugo Oba, Tokyo (JP)

Correspondence Address: SMITH, GAMBRELL & RUSSELL, 1850 M STREET, N.W., SUITE 800, WASHINGTON, DC, 20036, US

(21) Appl. No.: 11/413,594

(22) Filed: Apr. 28, 2006

(30) Foreign Application Priority Data
May 13, 2005 (JP) 2005-141512

(51) Int. Cl. B23K 26/38

(52) U.S. Cl. 219/121.69; 219/121.68

(57) ABSTRACT

A wafer laser processing method for forming a groove by applying a pulse laser beam to the back surface of a wafer comprising light emitting elements which are formed in a plurality of areas sectioned by a plurality of dividing lines on the front surface of a sapphire substrate, along the dividing lines, wherein an energy density of a focal spot of the pulse laser beam is set to 1 J/cm² or more.

### FIELD OF THE INVENTION

The present invention relates to a method for laser processing a wafer comprising light emitting elements, which are formed in a plurality of areas sectioned by dividing lines formed in a lattice pattern on the front surface of a sapphire substrate, and to a laser beam processing machine.

### DESCRIPTION OF THE PRIOR ART

An optical device wafer comprising light emitting elements, each having an n-type semiconductor and a p-type semiconductor made of a gallium nitride-based compound semiconductor and the like and formed in a plurality of areas sectioned by dividing lines formed in a lattice pattern on the front surface of a sapphire substrate and the like, is divided into individual optical devices such as light emitting diodes along the dividing lines, and the light emitting diodes are widely used in electric appliances.

Cutting along the dividing lines of this optical device wafer is generally carried out by a cutting machine for cutting by rotating a cutting blade at a high speed. However, since it is difficult to cut the sapphire substrate due to its high Moh's hardness, the processing speed must be slowed down, thereby reducing productivity.

As a means of dividing a plate-like workpiece such as a wafer, a method in which a groove is formed by applying a pulse laser beam along dividing lines formed on the workpiece and the workpiece is divided along the grooves by a mechanical breaking device is disclosed by JP-A 10-305420.

Further, a method in which a groove is formed by applying a pulse laser beam having absorptivity for a sapphire substrate to the substrate is disclosed by JP-A 2004-9139.

To form a groove in the optical device wafer comprising the sapphire substrate, a pulse laser beam is applied from the back surface of the sapphire substrate along the dividing lines. However, this method has the following problem. That is, as the energy of the pulse laser beam has a Gaussian distribution, the energy density is the highest at the center of the focal spot of the pulse laser beam and becomes lower toward its periphery gradually. Therefore, the outer peripheral portion of the focal spot of the pulse laser beam does not have a sufficiently high energy density required for processing the sapphire substrate. A pulse laser beam having a low energy density that does not contribute to processing, however, has a problem that it passes through the sapphire substrate to act on a light emitting element formed on the front surface and damage it, thereby reducing brightness.

### SUMMARY OF THE INVENTION

It is an object of the present invention to provide a wafer laser processing method and a laser beam processing machine, both of which are capable of forming a groove along dividing lines in the back surface of a sapphire substrate without damaging light emitting elements formed on the front surface of the sapphire substrate.

As a result of researches conducted by the inventors of the present invention, it has been found that when a pulse laser beam is applied to a sapphire substrate, an area having an energy density of 1 J/cm² or more of the focal spot of the pulse laser beam contributes to processing and an area having an energy density of less than 1 J/cm² of the focal spot of the pulse laser beam does not contribute to processing. It has also been found that a pulse laser beam having an energy density of less than 1 J/cm² passes through the sapphire substrate.

Accordingly, to solve the above main technical problem, according to the present invention, there is provided a wafer laser processing method for forming a groove by applying a pulse laser beam to the back surface of a wafer comprising light emitting elements which are formed in a plurality of areas sectioned by a plurality of dividing lines on the front surface of a sapphire substrate, along the dividing lines, wherein
an energy density in a focal spot of the pulse laser beam is set to 1 J/cm² or more.

An area having an energy density of less than 1 J/cm² of the focal spot of the above pulse laser beam is cut off by a mask means. The focal spot of the pulse laser beam passing through the mask means is formed into an elliptic shape, a major axis of the elliptic focal spot is aligned with a dividing line, the focal spot and the wafer are processing-fed relative to each other along the dividing line, and an overlap rate of the focal spots is set to 75 to 95%.

According to the present invention, there is also provided a laser beam processing machine for forming a groove by applying a pulse laser beam to the back surface of a wafer comprising light emitting elements which are formed in a plurality of areas sectioned by a plurality of dividing lines on the front surface of a sapphire substrate, along the dividing lines, the machine comprising a chuck table for holding the wafer, a laser beam application means for applying a pulse laser beam to the wafer held on the chuck table, a processing-feed means for moving the chuck table and the laser beam application means relative to each other in a processing-feed direction, and a control means for controlling the laser beam application means and the processing-feed means, wherein
the laser beam application means applies the pulse laser beam to ensure that an energy density of its focal spot becomes 1 J/cm² or more.

The above laser beam application means comprises a mask means for cutting off an area having an energy density of less than 1 J/cm² of the focal spot of the pulse laser beam and applies only an area having an energy density of 1 J/cm² or more of the pulse laser beam to the wafer. The mask means is composed of a mask having an elliptic opening, the major axis of the elliptic focal spot of the pulse laser beam applied through the elliptic opening is constituted so as to be aligned with the processing-feed direction, and the above control means controls the laser beam application means and the processing-feed means to ensure that the overlap rate {1×V/(H×L)}×100% of the elliptic focal spots becomes 75 to 95% when the length of the major axis of the elliptic focal spot is represented by L (μm), a repetition frequency of the pulse laser beam is represented by H (Hz), and the processing-feed rate is represented by V (μm/sec).

According to the present invention, since a pulse laser beam having an energy density of 1 J/cm² or more is applied to a wafer comprising a sapphire substrate and as a laser beam having an energy density of less than 1 J/cm² which does not contribute to processing is not applied to the sapphire substrate, the laser beam does not act on the light emitting elements through the substrate. Consequently, a reduction in the brightness of the light emitting elements caused by the damage of the light emitting elements due to the action of the laser beam on the light emitting elements can be prevented in advance.

### BRIEF DESCRIPTION OF THE DRAWINGS

FIG. 1 is a perspective view of a laser beam processing machine constituted according to the present invention;

FIG. 2 is a block diagram schematically showing the constitution of laser beam application means provided in the laser beam processing machine shown in FIG. 1;

FIG. 3 is an explanatory diagram of a processing head constituting the laser beam application means shown in FIG. 2;

FIG. 4 is a plan view of another embodiment of a mask member provided in the processing head shown in FIG. 3;

FIG. 5 is a perspective view of an optical device wafer as a wafer to be laser-processed by the present invention;

FIG. 6 is an enlarged sectional view of the principal portion of the optical device wafer shown in FIG. 5;

FIG. 7 is a perspective view of a state of the optical device wafer shown in FIG. 5 having a protective tape put on the front surface;

FIGS. 8(a) and 8(b) are explanatory diagrams showing a laser beam application step for laser processing the optical device wafer by the laser beam processing machine shown in FIG. 1;

FIG. 9 is an enlarged sectional view of the principal portion of the optical device wafer which has been laser processed by the laser beam application step shown in FIGS. 8(a) and 8(b); and

FIG. 10 is an explanatory diagram showing a state where the focal spots of a pulse laser beam applied in the laser beam application step shown in FIGS. 8(a) and 8(b) overlap with one another.

### DETAILED DESCRIPTION OF THE PREFERRED EMBODIMENTS

Preferred embodiments of the wafer laser processing method and laser beam processing machine according to the present invention will be described in detail hereinunder with reference to the accompanying drawings.

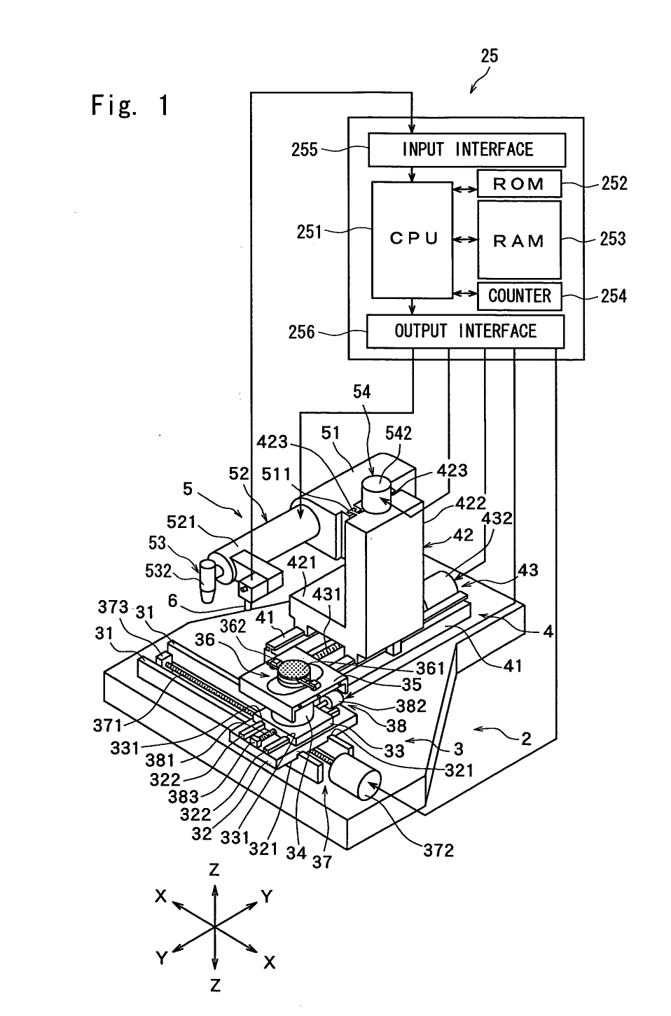

FIG. 1 is a perspective view of a laser beam processing machine constituted according to the present invention. The laser beam processing machine shown in FIG. 1 comprises a stationary base 2, a chuck table mechanism 3 for holding a workpiece, which is mounted on the stationary base 2 in such a manner that it can move in a processing-feed direction indicated by an arrow X, a laser beam application unit support mechanism 4 mounted on the stationary base 2 in such a manner that it can move in an indexing-feed direction indicated by an arrow Y perpendicular to the direction indicated by the arrow X, and a laser beam application unit 5 mounted onto the laser beam application unit support mechanism 4 in such a manner that it can move in a direction indicated by an arrow Z.

The above chuck table mechanism 3 comprises a pair of guide rails 31 and 31 that are mounted on the stationary base 2 and arranged parallel to each other in the processing-feed direction indicated by the arrow X, a first sliding block 32 mounted on the guide rails 31 and 31 in such a manner that it can move in the processing-feed direction indicated by the arrow X, a second sliding block 33 mounted on the first sliding block 32 in such a manner that it can move in the indexing-feed direction indicated by the arrow Y, a support table 35 supported on the second sliding block 33 by a cylindrical member 34, and a chuck table 36 as workpiece holding means. This chuck table 36 has an adsorption chuck 361 made of a porous material, and a workpiece, for example, a disk-like wafer is held on the adsorption chuck 361 by a suction means that is not shown. The chuck table 36 constituted as described above is rotated by a pulse motor (not shown) installed in the cylindrical member 34. The chuck table 36 is provided with clamps 362 for fixing an annular frame, which will be described later.

The above first sliding block 32 has, on its undersurface, a pair of to-be-guided grooves 321 and 321 to be fitted to the above pair of guide rails 31 and 31 and, on its top surface, a pair of guide rails 322 and 322 formed parallel to each other in the indexing-feed direction indicated by the arrow Y. The first sliding block 32 constituted as described above can move along the pair of guide rails 31 and 31 in the processing-feed direction indicated by the arrow X by fitting the to-be-guided grooves 321 and 321 to the pair of guide rails 31 and 31, respectively. The chuck table mechanism 3 in the illustrated embodiment comprises a processing-feed means 37 for moving the first sliding block 32 along the pair of guide rails 31 and 31 in the processing-feed direction indicated by the arrow X. The processing-feed means 37 comprises a male screw rod 371 that is arranged between the above pair of guide rails 31 and 31 in parallel thereto, and a drive source such as a pulse motor 372 for rotary-driving the male screw rod 371. The male screw rod 371 is, at its one end, rotatably supported to a bearing block 373 fixed on the above stationary base 2 and is, at the other end, transmission-coupled to the output shaft of the above pulse motor 372. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the processing-feed direction indicated by the arrow X.

The above second sliding block 33 has, on its undersurface, a pair of to-be-guide grooves 331 and 331 to be fitted to the pair of guide rails 322 and 322 on the top surface of the above first sliding block 32 and can move in the indexing-feed direction indicated by the arrow Y by fitting the to-be-guide grooves 331 and 331 to the pair of guide rails 322 and 322, respectively. The chuck table mechanism 3 in the illustrated embodiment comprises a first indexing-feed means 38 for moving the second sliding block 33 in the indexing-feed direction indicated by the arrow Y along the pair of guide rails 322 and 322 on the first sliding block 32. The first indexing-feed means 38 comprises a male screw rod 381 which is arranged between the above pair of guide rails 322 and 322 in parallel thereto, and a drive source such as a pulse motor 382 for rotary-driving the male screw rod 381. The male screw rod 381 is, at its one end, rotatably supported to a bearing block 383 fixed on the top surface of the above first sliding block 32 and is, at the other end, transmission-coupled to the output shaft of the above pulse motor 382. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the indexing-feed direction indicated by the arrow Y.

The above laser beam application unit support mechanism 4 comprises a pair of guide rails 41 and 41 that are mounted on the stationary base 2 and arranged parallel to each other in the indexing-feed direction indicated by the arrow Y and a movable support base 42 mounted on the guide rails 41 and 41 in such a manner that it can move in the direction indicated by the arrow Y. This movable support base 42 consists of a movable support portion 421 movably mounted on the guide rails 41 and 41 and a mounting portion 422 mounted on the movable support portion 421. The mounting portion 422 is provided with a pair of guide rails 423 and 423 extending parallel to each other in the direction indicated by the arrow Z on one of its flanks. The laser beam application unit support mechanism 4 in the illustrated embodiment comprises a second indexing means 43 for moving the movable support base 42 along the pair of guide rails 41 and 41 in the indexing-feed direction indicated by the arrow Y. This second indexing means 43 has a male screw rod 431 that is arranged between the above pair of guide rails 41 and 41 in parallel thereto, and a drive source such as a pulse motor 432 for rotary-driving the male screw rod 431. The male screw rod 431 is, at its one end, rotatably supported to a bearing block (not shown) fixed on the above stationary base 2 and is, at the other end, transmission coupled to the output shaft of the above pulse motor 432. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction indicated by the arrow Y.

The laser beam application unit 5 in the illustrated embodiment comprises a unit holder 51 and a laser beam application means 52 secured to the unit holder 51. The unit holder 51 has a pair of to-be-guided grooves 511 and 511 to be slidably fitted to the pair of guide rails 423 and 423 on the above mounting portion 422 and is supported in such a manner that it can move in the direction indicated by the arrow Z by fitting the guide grooves 511 and 511 to the above guide rails 423 and 423, respectively.

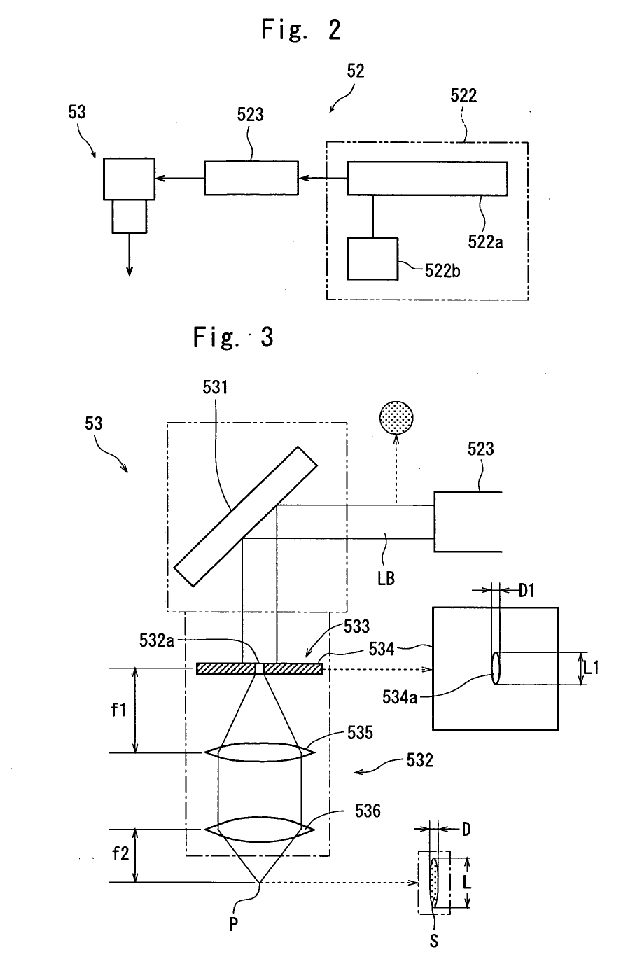

The illustrated laser beam application means 52 comprises a cylindrical casing 521 that is secured to the above unit holder 51 and extends substantially horizontally. The laser beam application means 52 comprises, as shown in FIG. 2, a pulse laser beam oscillation means 522 and a transmission optical system 523, which are installed in the casing 521, and a processing head 53 that is mounted on the end of the casing 521 and serves to apply a pulse laser beam oscillated from the pulse laser beam oscillation means 522 to the workpiece held on the above chuck table 36. The above pulse laser beam oscillation means 522 is constituted by a pulse laser beam oscillator 522a composed of a YAG laser oscillator or YVO4 laser oscillator and a repetition frequency setting means 522b connected to the pulse laser beam oscillator 522a. The transmission optical system 523 has suitable optical elements such as a beam splitter, etc.

The above processing head 53 comprises a direction changing mirror 531 and a condenser 532, as shown in FIG. 3. The direction changing mirror 531 changes the direction of a pulse laser beam, which is oscillated from the above pulse laser beam oscillation means 522 and applied through the transmission optical system 523, toward the condenser 532.

The condenser 532 comprises a mask means 533, a first condenser lens 535 and a second condenser lens 536 in the illustrated embodiment and focuses a laser beam passing through the mask means 533 at the focal spot position P of the second condenser lens 536 through the first condenser lens 535 and the second condenser lens 536. The mask means 533 is composed of a mask member 534 having an elliptic opening 534a in the illustrated embodiment. The opening 534a formed in the mask member 534 cuts off an area having an energy density of less than 1 J/cm² so that the energy density of the focal spot of the laser beam converged by the above second condenser lens 536 becomes 1 J/cm² or more. When the diameter of a pulse laser beam LB oscillated from the above pulse laser beam oscillation means 522 is 1 mm, the lengths of a minor axis (D1) and the major axis (L1) of the opening 534a of the mask member 534 in the illustrated embodiment are set to be 0.05 mm and 0.2 mm, respectively. It is desired that the ratio of the length of the minor axis (D1) to the length of the major axis (L1) should be set to a range of 1:1.5 to 1:100. The thus formed mask member 534 is positioned at the focal distance (f1) of the first condenser lens 535. In the condenser 532 constituted as described above, when the focal distance of the first condenser lens 535 is represented by (f1) and the focal distance of the second condenser lens 536 is represented by (f2), a magnification (m) of the image of the opening 534a of the mask member 534 formed by the second condenser lens 536 becomes m=f2/f1. Therefore, the pulse laser beam, which has passed through the opening 534a of the mask member 534 and has an elliptic section, forms an image of a focal spot S having an elliptic section at the focal spot position P of the second condenser lens 536 at a magnification of f2/f1. Consequently, when the focal distance (f1) of the first condenser lens 535 is 100 mm, the focal distance (f2) of the second condenser lens 536 is 10 mm, the length of the minor axis (D1) of the opening 534a of the above mask member 534 is 0.05 mm, and the length of the major axis (L1) of the opening 534a is 0.2 mm, the length of the minor axis (D) of the focal spot S becomes 5 μm and the length of the major axis (L) of the focal spot S becomes 20 μm.

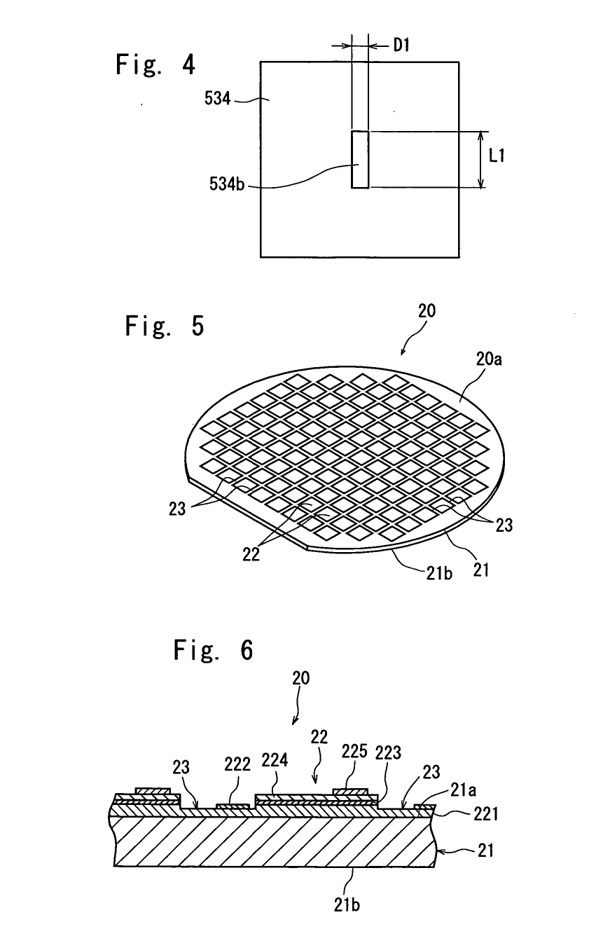

In the above embodiment, the elliptic opening 534a is shown as the opening formed in the mask member 534 of the mask means 533. As shown in FIG. 4, the opening formed in the mask member 534 may be a rectangular opening 534b. In the illustrated embodiment, the length of the minor axis (D1) of this rectangular opening 534b is set to 0.05 mm and the length of the major axis (L1) is set to 0.2 mm. It is desired that the ratio of the length of the minor axis (D1) to the length of the major axis (L1) of the rectangular opening 534b should be set to 1:1.5 to 1:100.

Returning to FIG. 1, an image pick-up means 6 for detecting the area to be processed by the above laser beam application means 52 is mounted onto the front end portion of the casing 521 constituting the above laser beam application means 52. This image pick-up means 6 is constituted by an infrared illuminating means for applying infrared radiation to the workpiece, an optical system for capturing the infrared radiation applied by the infrared illuminating means, and an image pick-up device (infrared CCD) for outputting an electric signal corresponding to the infrared radiation captured by the optical system in addition to an ordinary pick-up device (CCD) for picking up an image with visible radiation, in the illustrated embodiment. An image signal is supplied to a control means that is not shown.

The laser beam application unit 5 in the illustrated embodiment comprises a moving means 54 for moving the unit holder 51 along the pair of guide rails 423 and 423 in the direction indicated by the arrow Z. The moving means 54 comprises a male screw rod (not shown) arranged between the pair of guide rails 423 and 423 and a drive source such as a pulse motor 542 for rotary-driving the male screw rod. By driving the male screw rod (not shown) in a normal direction or reverse direction with the pulse motor 542, the unit holder 51 and the laser beam application means 52 are moved along the guide rails 423 and 423 in the direction indicated by the arrow Z. In the illustrated embodiment, the laser beam application means 52 is moved up by driving the pulse motor 532 in a normal direction and moved down by driving the pulse motor 532 in the reverse direction.

The laser beam processing machine in the illustrated embodiment comprises the control means 25. The control means 25 is composed of a computer which comprises a central processing unit (CPU) 251 for carrying out arithmetic processing based on a control program, a read-only memory (ROM) 252 for storing the control program, etc., a read/write random access memory (RAM) 253 for storing the results of operations, a counter 254, an input interface 255 and an output interface 256. A detection signal from the above image pick-up means 6, etc. is input to the input interface 255 of the control means 25. Control signals are output from the output interface 256 of the control means 25 to the pulse motor 372, the pulse motor 382, the pulse motor 432, the pulse motor 542 and the laser beam application means 52.

The laser beam processing machine in the illustrated embodiment is constituted as described above, and its function will be described hereinbelow.

An optical device wafer as the workpiece to be processed by the above laser beam processing machine will be described with reference to FIG. 5 and FIG. 6. FIG. 5 is a perspective view of the optical device wafer and FIG. 6 is an enlarged sectional view of the principal portion of the optical device wafer shown in FIG. 5.

The optical device wafer 20 shown in FIG. 5 and FIG. 6 comprises a plurality of light emitting elements 22 that are formed in a matrix on the front surface 21a of a sapphire substrate 21. The light emitting elements 22 are sectioned by dividing lines 23 formed in a lattice pattern. Each of the light emitting elements 22 is composed of an n-type semiconductor layer 221 formed on the front surface 21a of the sapphire substrate 21, an n-type electrode 222 formed on the surface of the n-type semiconductor layer 221, a p-type semiconductor layer 224 formed on the surface of the n-type semiconductor layer 221 through an active layer 223, and a p-type electrode 225 formed on the surface of the p-type semiconductor layer 224, as shown in FIG. 6.

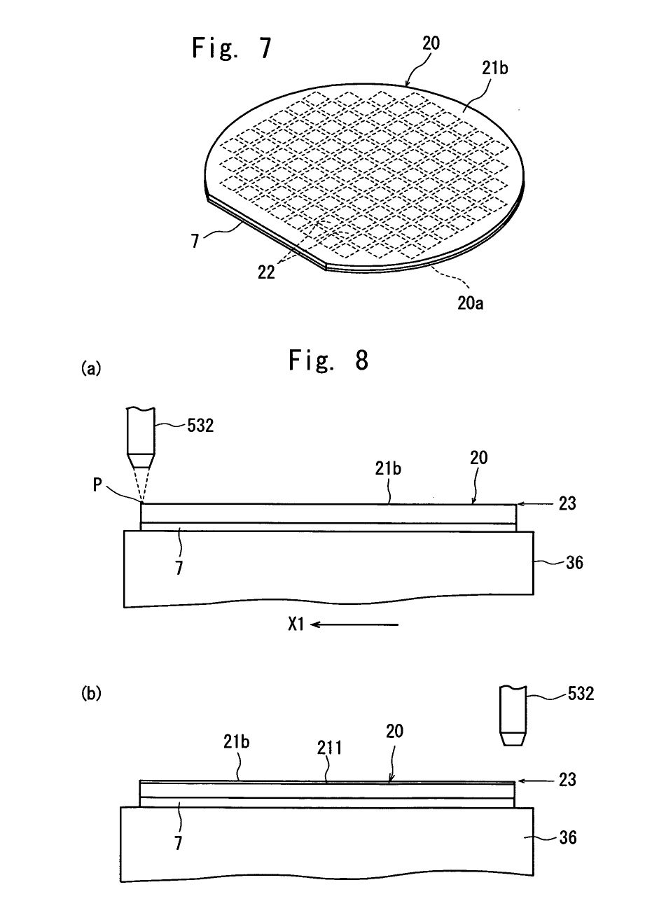

To carry out laser processing on the back surface of the optical device wafer 20 constituted as described above, that is, the back surface 21b of the sapphire substrate 21, a protective tape 7 is affixed to the front surface 20a of the optical device wafer 20, as shown in FIG. 7 (protective tape affixing step).

After the above protective tape affixing step, next comes a laser beam application step for forming a groove along the dividing lines 23 in the back surface 21b of the sapphire substrate 21 of the optical device wafer 20. For this laser beam application step, the protective tape 7 side of the optical device wafer 20 is first placed on the chuck table 36 of the above-described laser beam processing machine shown in FIG. 1, and suction-held on the chuck table 36. Therefore, the optical device wafer 20 is held in such a manner that the back surface 21b of the sapphire substrate 21 faces up.

The chuck table 36 suction-holding the optical device wafer 20 as described above is brought to a position right below the image pick-up means 6 by the processing-feed means 37. After the chuck table 36 is positioned right below the image pick-up means 6, alignment work for detecting the area to be processed of the optical device wafer 20 is carried out by the image pick-up means 6 and the control means that is not shown. That is, the image pick-up means 6 and the control means carry out image processing such as pattern matching, etc. to align a dividing line 23 formed in a predetermined direction of the optical device wafer 20 with the condenser 532 of the laser beam application means 52 for applying a laser beam along the dividing line 23, thereby performing the alignment of a laser beam application position. The alignment of the laser beam application position is also carried out on dividing lines 23 formed on the optical device wafer 20 in a direction perpendicular to the above predetermined direction. Although the front surface 20a, on which the dividing line 23 is formed, of the optical device wafer 20 faces down at this point, an image of the dividing line 23 can be picked up from the back surface 21b of the substrate 21 as the image pick-up means 6 has an infrared illuminating means and the image pick-up means constituted by an optical system for capturing infrared radiation and an image pick-up device (infrared CCD) for outputting an electric signal corresponding to the infrared radiation, as described above.

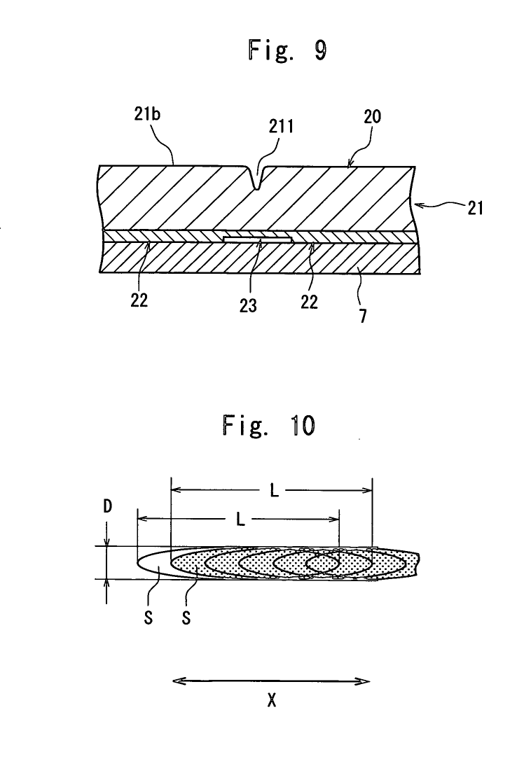

After the alignment of the laser beam application position is carried out by detecting the dividing line 23 formed on the optical device wafer 20 held on the chuck table 36 as described above, the chuck table 36 is moved to a laser beam application area where the condenser 532 of the laser beam application means 52 is located, to position the predetermined dividing line 23 right below the condenser 532, as shown in FIG. 8(a). At this point, the optical device wafer 20 is positioned such that one end (left end in FIG. 8(a)) of the dividing line 23 is located right below the condenser 532 as shown in FIG. 8(a). The major axis (L) (see FIG. 3) of the elliptic focal spot S of a pulse laser beam applied from the condenser 532 is aligned with the processing-feed direction X. The chuck table 36, that is, the optical device wafer 20 is then moved in the direction indicated by the arrow X1 in FIG. 8(a) at a predetermined processing-feed rate while a laser beam is applied from the condenser 532. When the other end (right end in FIG. 8(b)) of the dividing line 23 reaches a position right below the condenser 532 as shown in FIG. 8(b), the application of the pulse laser beam is suspended and the movement of the chuck table 36, that is, the optical device wafer 20 is stopped. As a result, a uniform groove 211 is formed along the predetermined dividing line 23 as shown in FIG. 9 in the back surface 21b of the sapphire substrate 21 of the optical device wafer 20.

In the above laser beam application step, the pulse laser beam applied from the condenser 532 of the laser beam application means 52 has an elliptic focal spot S and is applied to the optical device wafer 20 as described above, and the energy density of the focal spot S of this pulse laser beam is set to 1 J/cm² or more by the above mask member 534. That is, the opening 534a of the mask member 534 is formed to a size for cutting off an area having an energy density of less than 1 J/cm², so that the energy density of the focal spot S of the pulse laser beam LB oscillated from the pulse laser beam oscillation means 522 becomes 1 J/cm² or more. Therefore, since a laser beam having an energy density of less than 1 J/cm², which does not contribute to processing, is not applied to the sapphire substrate 21 of the optical device wafer 20, it does not act on the semiconductor layers of the light emitting elements 22 through the substrate 21. Consequently, the damage (a reduction in the brightness of the light emitting elements) of the semiconductor layers caused by the application of the laser beam to the semiconductor layers of the light emitting elements 22 can be prevented in advance.

As another means of obtaining the focal spot of the laser beam which does not form an area having an energy density of less than 1 J/cm², there is a method in which an a spherical lens is used to homogenize a laser beam so as to obtain a 1 J/cm² or more energy distribution, or a method in which a 1 J/cm² or more energy distribution is obtained on a substrate by using diffraction optical elements (DOE).

In the above laser beam application step, the pulse laser beam applied from the condenser 532 of the laser beam application means 52 has an elliptic focal spot S and is applied to the back surface 21b of the sapphire substrate 21 of the optical device wafer 20, and the pulse laser beam is applied such that most of its elliptic focal spots S overlap with one another in the processing-feed direction X, as shown in FIG. 10. The amount of this overlap, that is, the overlap rate of the elliptic focal spots S is set as follows in the illustrated embodiment. That is, when the length of the major axis of the elliptic focal spot S is represented by L (μm), the frequency of the pulse laser beam is represented by H (Hz) and the processing-feed rate is represented by V (μm/sec), the overlap rate {1−V/(H×L)}×100% of the elliptic focal spots S is set to become 75 to 95%. This overlap rate {1−V/(H×L)}×100% of the elliptic focal spots S is set by controlling the above laser beam application means 52 and the processing-feed means 37 by means of the control means 25. That is, the control means 25 controls the repetition frequency setting means 522b of the laser beam application means 52 to suitably set the repetition frequency of the pulse laser beam oscillated by the pulse laser beam oscillation means 522 and the revolution of the pulse motor 372 of the processing-feed means 37 so that the overlap rate {1−V/(H×L)}×100% of the elliptic focal spots S becomes 75 to 95%.

Here, the overlap rate {1−V/(H×L)}×100% of the elliptic focal spots S having a minor axis (D) of 5 μm and a major axis (L) of 20 μm will be discussed hereinunder. In this case, when the repetition frequency of the pulse laser beam is 30 kHz and the processing-feed rate is 100 mm/sec, as the workpiece moves 3.33 μm before the next pulse laser beam is applied, the overlap rate {1−V/(H×L)}×100% is 83%. When the feed rate is changed to 300 mm/sec and the repetition frequency remains at 30 kHz, the overlap rate {1−V/(H×L)}×100% drops to 50%. Therefore, to maintain the overlap rate {1−V/(H×L)}×100% at 75% or more, the repetition frequency must be set to 60 kHz or more.

After the above laser beam application step is carried out along all the dividing lines 21 formed in the predetermined direction of the optical device wafer 20, the chuck table 36, therefore, the optical device wafer 20 is turned at 90°. The above laser beam application step is then carried out along all the dividing lines 23 formed in a direction perpendicular to the above predetermined direction of the optical device wafer 20.

After the above laser beam application step is carried out along all the dividing lines 23 formed on the optical device wafer 20 as described above, the optical device wafer 20 is carried to the subsequent dividing step. In the dividing step, as the grooves 211 that have been formed along the dividing lines 23 of the optical device wafer 20 are deep enough to facilitate division, the optical device wafer 20 can be easily divided by mechanical breaking.

### Example

The above laser beam application step was set as follows and formed grooves along the dividing lines of the above optical device wafer.
Processing conditions of laser beam application step:
   Light source: YAG or YVO4 laser
   Wavelength: 355 nm
   Repetition frequency: 70 kHz
   Focal spot: elliptic with a minor axis of 7 μm and a major axis of 23 μm
   Pulse energy: 0.016 mJ
   Processing-feed rate: 100 mm/sec

After the groove was formed along the dividing lines of the optical device wafer as described above, the optical device wafer was divided along the grooves by mechanical breaking to form individual optical devices. When the brightness of the optical device wafer was measured, it was 25 μA.

Meanwhile, when the brightness of an optical device obtained by forming a groove in an optical device wafer by an ordinary laser processing method in which a pulse laser beam oscillated from pulse laser beam oscillation means was entirely applied without being masked was measured, it was 24 μA.

Thus, the optical device obtained by the laser processing method of the present invention had 4.3% higher brightness than the optical device obtained by the ordinary laser processing method. The brightness of the optical device obtained by the laser processing method of the present invention is substantially the same as the brightness of an optical device obtained by dividing an optical device wafer with a diamond scriber.

What is claimed is:

1. A wafer laser processing method for forming a groove by applying a pulse laser beam to the back surface of a wafer comprising light emitting elements which are formed in a plurality of areas sectioned by a plurality of dividing lines on the front surface of a sapphire substrate, along the dividing lines, wherein
an energy density of a focal spot of the pulse laser beam is set to 1 J/cm² or more.

2. The wafer laser processing method according to claim 1, wherein an area having an energy density of less than 1 J/cm² of the focal spot of the pulse laser beam is cut off by a mask means.

3. The wafer laser processing method according to claim 2, wherein the focal spot of the pulse laser beam passing through the mask means is formed into an elliptic form, a major axis of the elliptic focal spot is aligned with a dividing line, the focal spot and the wafer are processing-fed relative to each other along the dividing line, and an overlap rate of the focal spots is set to 75 to 95%.

4. A laser beam processing machine for forming a groove by applying a pulse laser beam to the back surface of a wafer comprising light emitting elements which are formed in a plurality of areas sectioned by a plurality of dividing lines on the front surface of a sapphire substrate, along the dividing lines, the machine comprising a chuck table for holding the wafer, a laser beam application means for applying a pulse laser beam to the wafer held on the chuck table, a processing-feed means for moving the chuck table and the laser beam application means relative to each other in a processing-feed direction, and a control means for controlling the laser beam application means and the processing-feed means, wherein
the laser beam application means applies the pulse laser beam to ensure that an energy density of its focal spot becomes 1 J/cm² or more.

5. The laser beam processing machine according to claim 4, wherein the laser beam application means comprises a mask means for cutting off an area having an energy density of less than 1 J/cm² of the focal spot of the pulse laser beam and applies only an area having an energy density of 1 J/cm² or more of the pulse laser beam to the wafer.

6. The laser beam processing machine according to claim 5, wherein the mask means is composed of a mask having an elliptic opening, the major axis of the elliptic focal spot of the pulse laser beam applied through the elliptic opening is constituted so as to be aligned with the processing-feed direction, and the control means controls the laser beam application means and the processing-feed means to ensure that the overlap rate {1−V/(H×L)}×100% of the elliptic focal spots becomes 75 to 95% when the length of the major axis of the elliptic focal spot is represented by L (μm), the repetition frequency of the pulse laser beam is represented by H (Hz), and the processing-feed rate is represented by V (μm/sec).
